(19) United States
(12) Patent Application Publication
(10) Pub. No.: US 2008/0073279 A1
(43) Pub. Date: Mar. 27, 2008

(54) High Rate Clarification of Cooling Water Using Magnetite Seeding and Separation

(76) Inventor: Steven L. Cort, Cary, NC (US)

Correspondence Address: Coats & Bennett, PLLC/Michael deAngeli, 1400 Crescent Green, Suite 300, Cary, NC, 27581, US

(21) Appl. No.: 11/862,549

(22) Filed: Sep. 27, 2007

Related U.S. Application Data
(60) Provisional application No. 60/847,383, filed on Sep. 27, 2006.

(51) Int. Cl. C02F 9/12; C02F 1/48; C02F 9/00

(52) U.S. Cl. 210/695

(57) ABSTRACT

A method and system for treating cooling water and removing scalants therefrom. The cooling water is directed into a chamber. Magnetic seed is mixed with the cooling water causing the scalants to attach to the magnetic seed to form magnetic particles. These magnetic particles are collected on a magnetic collector so as to remove the scalants from the cooling water. The method and system further removes the magnetic particles from the magnetic collector.

### CROSS REFERENCE TO RELATED APPLICATION

This application claims priority under 35 U.S.C. §119(e) from the following U.S. provisional application: Application Ser. No. 60/847,383 filed on Sep. 27, 2006. That application is incorporated in its entirety by reference herein.

### FIELD OF THE INVENTION

This invention is in the technical field of clarifying cooling water that has been chemically treated to precipitate scalants and corrosive chemicals, principally calcium, magnesium, silica, sulfate, and chloride. High rate clarification is performed using magnetic seeding and separation.

### BACKGROUND OF THE INVENTION

The current trend in industrial wastewater management focuses on pollution prevention, both by source reduction, that is, use of clean technologies to reduce the pollution introduced, and by use of closed water systems, in which water recycling plays a major role. Cooling water discharges are major environmental problems, constituting from 60 to 90% by volume of industrial discharges. Heat, toxic chemicals, and organic and inorganic materials are contained in these discharges. Furthermore, cooling water contributes the highest single water demand in industry, which accounted for 49% of all water withdrawals in 1990.

In cooling water applications where water evaporates, the concentration of dissolved chemicals builds up over time until a saturation point is reached. At this point the chemical(s) precipitate and deposit on heat transfer surfaces. This “scaling” impairs heat transfer and eventually will cause failure of the cooling equipment. Corrosive compounds such as chlorine will also build up until they cause damage to heat transfer surfaces.

One way to treat this problem is to “blow down” cooling water, that is, discharge rather than recirculate some fraction of the cooling water stream, in order to reduce the concentration of dissolved solids below the saturation point or corrosive point. However, this discharges pollution to the environment and increases the level of water treatment chemicals that have to be replaced in the cooling water at a significant cost.

An effective alternative to the discharge of cooling water is recycling. Blowdown from the cooling system can be chemically treated and reused. Mainstream technologies to treat boiler blow down include high lime (HL) softening, reverse osmosis, ion exchange, and electrodialysis. With the exception of high lime softening, all these technologies are very expensive and have many operating problems. For example, the unit price of water treatment of boiler blowdown with reverse osmosis is about three times the price of lime softening.

The conventional lime softening process is used in cooling water systems to precipitate the major scalants. However, it is not effective in removing silica. An attractive alternative to the lime softening process is the ultra-high lime process (UHL) that can remove silica in addition to the removal of the other major scalants.

A two-stage configuration for the UHL was investigated by Abdel-Wahab, infra. Excess lime is added to the cooling water stream in a first stage to achieve high calcium concentration and high pH (pH 11-pH 12). Silica, magnesium, and phosphate are removed in this stage as solid precipitates. In a second stage, inorganic carbon is added, for example as carbon dioxide or soda ash, to remove calcium by precipitation as calcium carbonate. The pH of the effluent from the second stage is adjusted to the value desired for the cooling water system. This process could be applied to remove scale-forming chemicals from the make-up to a cooling water system, to a sidestream of the recycled cooling water, or to both. Depending on the composition of the water to be treated, this configuration might be modified to operate more economically by having a fraction of the flow bypass the first stage. A configuration of the UHL that is particularly attractive for application to recycled cooling water systems is shown in FIG. 1, as discussed in detail below.

In this configuration, a sidestream of the recycled cooling water is treated by the UHL and the make-up stream is treated by lime softening. A number of significant advantages can be claimed for the UHL. One advantage is that it is capable of removing all major scale-forming chemicals regardless of the chemical composition of the water to be treated. However, UHL is not effective in removing sulfate and chloride.

The “ultra-high lime with aluminum process” (UHLA) has been around for some time. Original work was performed by Batchelor in about 1984. UHLA is an innovative modification of UHL in which aluminum is added to promote removal of sulfate and chloride. UHLA has excellent potential for improving industrial water use efficiency. It has the ability to remove most of the unwanted compounds that limit the extent of recycling at low cost. UHLA is not limited to treatment of recycled industrial cooling water, but could be applied to many different water treatment systems.

UHLA has demonstrated the ability to achieve high sulfate removal efficiency. The high pH and calcium concentration found in the first of the two stages allows for removal of sulfate by precipitation of calcium sulfoaluminate

The kinetics of sulfate removal by precipitation of calcium sulfoaluminate was found to be rapid enough for practical applications. Furthermore, aluminum has been found to promote silica removal by precipitation and adsorption mechanisms. Preliminary results also indicate that UHLA can remove chloride efficiently from recycled cooling water. In tests, the kinetics of chloride removal was also found to be rapid, being essentially complete within one hour.

Implementation of UHLA does not require development of new equipment. In fact, it may be practicable to convert existing lime softening plants that have been used for many years to UHLA with minor modifications. Operating costs of UHLA are expected to be slightly higher than those of conventional lime softening due to the need to add aluminum. However, the overall cost of UHLA, including aluminum cost, is still much lower than other treatment alternatives; for example, the estimated cost for UHLA is about one third that for reverse osmosis. Using aluminum present in waste sludge from water treatment plants as an aluminum source for the process will reduce the cost of the technology even more and offer the potential for developing UHLA as a more sustainable and cost-effective process.

Reusing UHLA sludges is an important environmental consideration since most of these waste sludges are normally landfilled. These sludges have physical and chemical properties that make them useful in many industrial and environmental applications. UHLA sludges are receiving considerable attention because they are used as anion exchange and absorption materials, carriers for drugs, antacids in medicine, electrode modifiers, catalysts, precursors and supports of catalysts, decoloring agents, polymer stabilizers, optical hosts and ceramic precursors. However, these sludges often contain heavy metals that precipitate along with the scaling agents, or “scalants”. The UHLA process operates at a high pH where many metals will precipitate as metal hydroxides. However, the high operating pH is not an optimum for all heavy metals to precipitate.

### SUMMARY OF THE INVENTION

A method of treating cooling water to remove scalants is disclosed. The method includes directing the cooling water into a chamber and mixing magnetic seed, such as magnetite, with the water such that scalants attach to the magnetic seed to form magnetic particles. These magnetic particles are collected on a magnetic collector, and after being collected on the magnetic collector, are removed therefrom.

In another embodiment, a method of removing scalants and suspended solids from water is disclosed wherein the method entails a multistage process utilizing magnetic seed and magnetic separation. This process includes, in a first chamber, mixing magnetic seed with the water and attracting scalants to the magnetic seed where the magnetic seed and scalants form magnetic particles. The magnetic particles are removed in the first chamber via a first magnetic collector. In a second chamber the water is mixed with magnetic seed and a flocculant, and through a flocculation process, suspended solids in the water are collected around the magnetic seed to form magnetic floc. Magnetic floc in the second chamber are removed by a second magnetic collector.

### BRIEF DESCRIPTION OF THE DRAWINGS

FIG. 1 is a schematic diagram of a system for cleaning water according to the invention.

FIG. 2 is a side elevation view of the equipment according to one embodiment of the invention.

### DETAILED DESCRIPTION OF THE INVENTION

According to one aspect of the present invention, sulfide precipitation is employed to remove heavy metal contaminants from UHLA sludges. Before the scalants are precipitated by UHLA, a sulfide precipitant is added to react with all divalent heavy metals in the coolant. This precipitates metals such as copper, zinc, iron, and nickel originating as heated surface corrosion products, trace metals that are not precipitated in the high lime softening of makeup water, and contaminants including trace metals found in water treatment chemicals. Sulfide precipitation of heavy metals is not generally sensitive to pH and therefore practically all of the divalent heavy metals can be removed. The precipitated heavy metal sulfides are removed from the cooling water before the scalants, and corrosion products are removed by UHLA. Therefore these sludges are relatively free of heavy metal contamination and are suitable for reuse.

More specifically, alum sludge, a waste product from water treatment, is a good source of aluminum to precipitate chlorine as calcium chloroaluminate. However, it contains trace amounts of heavy metals and other contaminants found in water. The potential use of this byproduct has significant cost and environmental benefits. The coolant is mixed with this sludge at a high pH (greater than 10) to dissolve the aluminum. Adding a sulfide to this waste stream according to this aspect of the invention will precipitate divalent heavy metals but not the aluminum. Therefore, the total suspended contaminants and heavy metals are first removed from the alum sludge, while the aluminum stays in solution and goes on to UHLA, where scalants and corrosives such as chlorine are removed. That is, in order to use waste sources of aluminum and to remove the dissolved heavy metals in the coolant, the process of the invention also includes a high alkaline precipitation of heavy metals with sulfides to keep the aluminum in solution and available for the UHLA process. Because aluminum is soluble at high and low pH, acid precipitation of the heavy metals with sulfide is an alternative that may be cost effective. However, in this mode, a sulfide precipitant that does not emit large amounts of toxic gases in an acid environment must be used, such as those taught in U.S. Pat. Nos. 5,451,327 and 5,762,807.

UHL sludges exhibit a design Surface Overflow Rate (SOR) of 1-1.3 gallons per minute per square foot of clarifier surface area. When aluminum is used, as in UHLA, the SOR is even lower or about 0.8 gpm/square foot. Therefore, large gravity clarifiers are required to settle UHLA sludge from cooling water. This is a significant barrier to adoption of UHLA.

According to another aspect of the present invention, high rate clarification, preferably magnetic separation, is performed to remove UHLA sludges efficiently, making UHLA practical. Optimally, three clarifiers are employed: one to separate solids from UHL used to treat blow down, one for treating makeup water using the HL softening process, and one for the removal of heavy metal sulfides and cleanup of waste aluminum sludge precipitated in the chlorine removal step.

In summary, the process of the invention typically treats cooling water in three possible treatment steps, each employing high rate clarification, preferably magnetic seeding and separation technology. The three steps are sulfide precipitation to remove heavy metals if necessary, UHL or UHLA, and HL softening.

Another advantage of using magnetic seeding in the cleaning of cooling water is in connection with the removal of silica, a significant problem in evaporative cooling water systems. Midkiff U.S. Pat. No. 6,416,672 describes a method for removing silica by depositing the silica on particles of a nucleation site material. By providing a large surface area of fine material, silica will scale on this surface area and reduce the scaling on heat transfer surfaces. However, Midkiff points out a potential problem: if the nucleation site material is too small, there will be excessive pressure losses and the nucleation site material will be difficult to remove from the cooling water. Magnetite is mentioned as a suitable nucleation site material but the magnetic properties of magnetite are not mentioned.

Therefore, the present process entails a scale removal system comprising a treatment reactor containing magnetite, a magnetite cleaning system, and a magnetic separator comprising permanent magnets. A magnetic clarifier removes suspended particles from the water flowing from the reactor, If a flocculating polymer used to bind the magnetite to particles to be removed presents a problem, e.g. fouling of heat transfer surfaces in the condenser, filtering may be employed.

According to the present invention, the process employs magnetite particles to provide nucleation sites for scale removal. Using fine magnetite will provide a very large surface area for the deposit of silica and the magnetite can be easily removed in a magnetic separator. That is, the ferromagnetic properties of the magnetite allow it and the particles to which it is bound to be easily removed from water with little pressure drop. It is anticipated that the magnetite cleaning process will abrade the silica off the magnetite so it can be reused; chemical cleaning is another option.

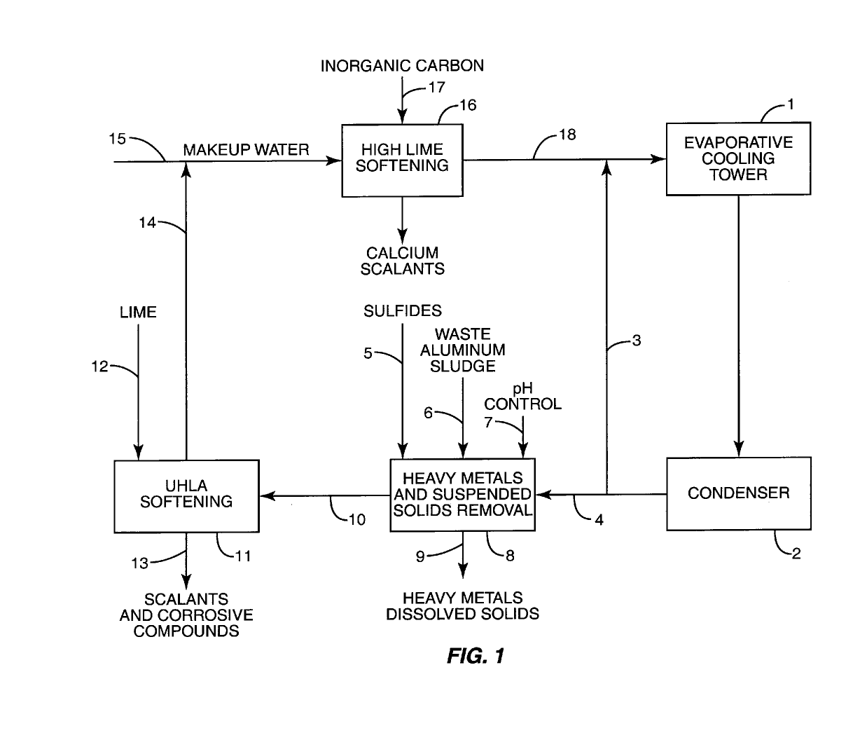

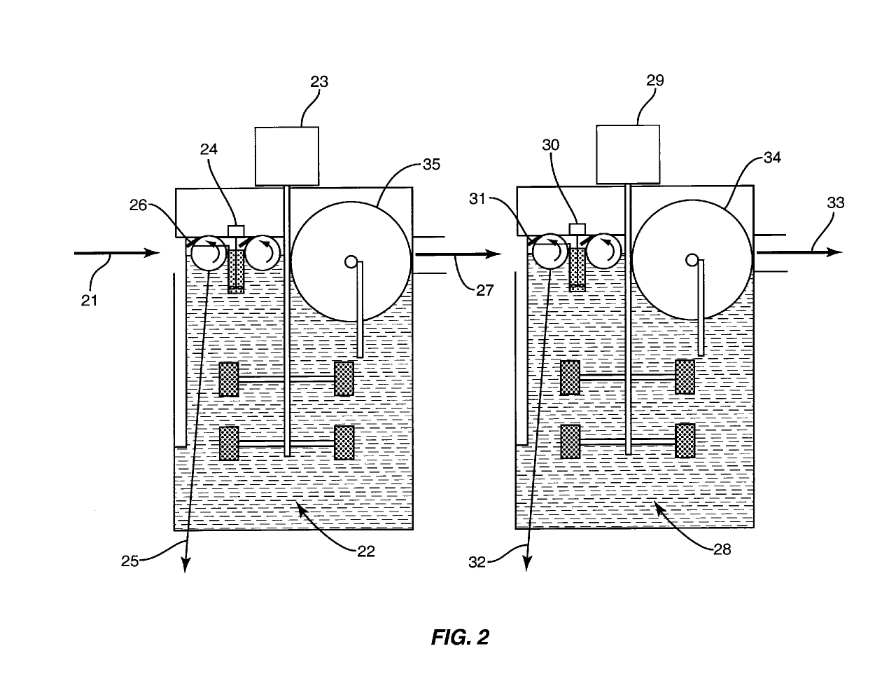

FIG. 1 depicts in schematic form a process for treating cooling water with lime, sulfides, aluminum sludge, and high rate clarification for removing precipitates that are formed at several different treatment process steps. FIG. 2, discussed below, shows schematically a system for removing dissolved chemicals that might otherwise form scale. The FIG. 2 system can be used in conjunction with the system of FIG. 1 where appropriate.

Thus, in FIG. 1, cooling water flows from an evaporative cooling tower 1 through a condenser 2 for cooling. The cooling water stream is recycled 3 back to the cooling tower and some portion of the flow 4 is diverted (blown down) to a heavy metal and suspended solids removal system 8. This is a high rate clarification system, preferably one employing magnetic seeding and separation technology. As mentioned above, according to one aspect of the present invention, this treatment system comprises addition of sulfides 5 for heavy metal precipitation, addition of waste aluminum sludge 6, preferably recovered from potable water treatment, for removal of sulfates and chlorides, and pH control 7 to maintain the pH at a level suitable to keep the aluminum in solution. Precipitated heavy metals and total dissolved solids from the aluminum source settle out and are discharged through a pipe 9 for disposal. The cooling water stream then flows through a pipe 10 to another high rate treatment system 11 that performs UHLA to remove scaling and corrosive compounds containing principally of calcium, magnesium, silica, sulfate, and chloride. This is accomplished by the addition of lime 12. The compounds precipitated in this stage and removed at 13 have higher commercial value since heavy metals and other contaminants have been removed in the prior treatment stage. Additional purification steps can be taken to increase the purity and value of these compounds. Water then flows 14 to a HL softening stage 16 that further treats the cooling water and new makeup water 15 with the addition of a source of inorganic carbon 17, preferably soda ash to remove some of the calcium scalants. The pollutants in the make up water and scale producing chemicals are removed at 19. The recycled cooling water then flows 18 back into the cooling system.

FIG. 2 shows a two-stage treatment system to remove dissolved chemicals that might otherwise form scale. Briefly, magnetite is employed as a sacrificial surface on which the scale forms, so that scale formation does not form on the heat transfer surface is reduced. Water flows 21 into a chamber or reactor 22 that contains magnetite, and is continually stirred with a mixer 23. Magnetite that has collected scale from the water is removed from the reactor by magnetic attraction and is then cleaned by a cleaning system 24 that removes scale from the magnetite by chemical treatment, or by mechanical means to abrade the scale off the magnetite. The cleaned magnetite is then returned to the stirred reactor 22 for reuse. Scale is disposed of through pipe 25. A magnetic collector 35 prevents the magnetite from exiting the stirred reactor 22. The first stirred reactor 22 removes scale from the cooling water. However, it does not remove suspended solids. This is accomplished when water flows 27 to a similarly-configured unit operated as a magnetic clarifier 28. The contents of the clarifier are continuously mixed by mixer 29, and a magnetite cleaning system 30 is also provided. This system returns cleaned magnetite for reuse 31 and disposes waste solids 32. Water then flows back to the cooling system 33. A magnetic collector 34 prevents the magnetite from leaving the magnetic clarifier 28.

Thus, the magnetic seed or magnetite used in chamber or reactor 22 functions to sorb scalant contaminants. When the magnetic seed or magnetite sorbs the contaminants, magnetic particles are formed. The mixing action in the chamber 22 maintains the magnetic particles in suspension, generally uniformly throughout the reactor 22. The magnetic cleaning system 24 collects the magnetic particles and cleans the magnetic seed from the magnetic particles after which the magnetic seed is reintroduced to reactor 22. In the other reactor 28, the method or process deals with removing suspended solids through a flocculation process involving magnetic seed such as magnetite. Here, a flocculant is added and mixed with the magnetic seed in the water in reactor 28. This forms magnetic floc, which is eventually removed from the reactor 28 via the cleaning system 30. In cases where the use of polymer for flocculation is not desirable, filtration can be substituted for magnetic separation.

In disclosing and describing the methods and systems for treating water, magnetic seeding and magnetic separation have been disclosed as a means of clarifying and removing solids from the water. Generally, magnetic seeding and separation entails mixing magnetic seed, such as magnetite, with the water being treated. Through flocculation, adsorption, absorption and other physical or chemical means, contaminants such as suspended solids, scalants, heavy metals, etc. attach to the magnetic seed to form magnetic particles or magnetic floc. In the case of flocculation, a coagulant and a flocculant may be mixed with the water. Typically, the process of magnetic separation entails utilizing a magnetic collector such as a rotary magnetic drum or a series of rotary magnetic disks. Such collectors are at least partially submerged in the water being treated and are driven. In the process, magnetic particles or magnetic floc are collected by the magnetic collector. These magnetic particles or magnetic floc are removed from the magnetic collector and directed to a shear chamber. In the shear chamber, the magnetic particles or magnetic floc are sheared, separating the magnetic seed and effectively producing magnetic seed and sludge. The same magnetic collector, or a second magnetic collector, can be utilized to collect the separated magnetic seed. After the magnetic seed has been collected by the magnetic collector, the seed is removed from the magnetic collector and returned to the same treatment tank or chamber, or otherwise recycled. The separated sludge is collected and directed from the system or process.

Reference is made to the magnetic seeding and subsequent separation techniques disclosed in application Ser. No. 11/503,951 (the '951 application) and U.S. Pat. No. 7,255,793. The disclosures of the '951 application and U.S. Pat. No. 7,255,793 are expressly incorporated herein by reference.

As used herein the term “water” includes water and all forms of wastewater. “High rate clarifiers” are defined as clarifiers that have a surface overflow rate greater than five gallons per minute per square foot of surface area.

The present invention may, of course, be carried out in other specific ways than those herein set forth without departing from the scope and the characteristics of the invention. The present embodiments are therefore to be construed in all aspects as illustrative and not restrictive and all changes coming within the meaning and equivalency range of the appended claims are intended to be embraced therein.

1. A method of treating cooling water and removing scalants therefrom, comprising:
a. directing the cooling water into a chamber;
b. mixing magnetic seed with the water and causing the scalants to attach to the magnetic seed to form magnetic particles;
c. collecting the magnetic particles on a magnetic collector so as to remove the scalants from the cooling water; and
d. removing the magnetic particles from the magnetic collector.

2. The method of claim 1 including:
a. chemically precipitating the scalants from the cooling water;
b. mixing a flocculant with the magnetic seed;
c. flocculating the precipitated scalants and magnetic seed to form magnetic floc comprising the magnetic seed and scalants;
d. collecting the magnetic floc on the magnetic collector; and
e. removing the magnetic floc from the magnetic collector.

3. The method of claim 2 including directing the magnetic floc to a shearing chamber; shearing the magnetic floc and separating the magnetic seed from the scalants to produce magnetic seed and sludge; removing the sludge; and recycling the magnetic seed.

4. The method of claim 1 including producing the cooling water by an evaporative cooling process and wherein the cooling water treated is a blowdown stream.

5. The method of claim 2 wherein chemically the cooling water includes treating the cooling water with a lime softening process; adding one or more sulfides to the cooling water and precipitating heavy metals from the cooling water.

6. The method of claim 5 including mixing waste aluminum sludge with the cooling water.

7. The method of claim 1 including treating the cooling water in at least two stages including in one stage precipitating and removing the scalants; and in a second stage adding a flocculant and mixing the flocculant with magnetic seed and removing suspended solids in the second stage by a flocculation process where the suspended solids agglomerate around the magnetic seed to form magnetic floc; and in the second stage, removing the magnetic floc by collecting the magnetic floc on a magnetic collector.

8. The method of claim 1 including maintaining the magnetic particles in suspension in a chamber; moving a magnetic collector through the cooling water in the chamber and collecting the magnetic particles that are in suspension in the chamber on the magnetic collector.

9. The method of claim 8 including removing the magnetic particles from the magnetic collector, directing the magnetic particles to a shear chamber, shearing the magnetic particles and separating the magnetic particles into magnetic seed and sludge; directing the sludge to a sludge receiving area; and recycling the magnetic seed for reuse.

10. The method of claim 9 wherein the magnetic collector comprises a rotary magnetic collector, and the method includes at least partially submerging the rotary magnetic collector in the cooling water and rotating the magnetic collector in the cooling water.

11. The method of claim 1 wherein the magnetic seed includes sacrificial scale surfaces.

12. The method of claim 1 wherein the magnetic seed includes magnetite or other ferromagnetic materials.

13. A method of removing contaminants including heavy metals, suspended solids and scalants from water, comprising the steps of:
a. in a first phase, precipitating heavy metals from the water by mixing one or more sulfides with the water, adding aluminum waste sludge to the water to remove sulfides and chloride, and maintaining the pH of the water at a level that maintains aluminum in solution;
b. in a second phase treating the water with a lime softening process to precipitate scalants and corrosive compounds taken from the group including calcium, magnesium, silica, sulfates and chloride;
c. in a third phase employing another lime softening process to remove additional contaminants;
d. in one or more of the phases of the process mixing magnetic seed with the water such that the contaminants attach to the magnetic seed and form magnetic particles;
e. collecting the magnetic particles with a magnetic collector so as to remove the scalants from the water; and
f. removing the magnetic particles from the magnetic collector.

14. The method of claim 13 including in the third phase mixing inorganic carbon with the water and removing calcium scalants from the water treated in the third phase.

15. A method of removing scalants and suspended solids in water in a multistage process utilizing magnetic seed and magnetic separation, the method comprising the steps of:
a. in a first chamber, mixing magnetic seed with the water and attracting scalants to the magnetic seed where the scalants attach to the magnetic seed and form magnetic particles;
b. collecting the magnetic particles in the first chamber of a first magnetic collector;
c. removing the magnetic particles from the first magnetic collector and separating the seed from the magnetic particles and recycling the magnetic seed to the first chamber;
d. in a second chamber, mixing magnetic seed and a flocculant with the water and flocculating the mixture causing suspended solids to be attached to the magnetic seed and form magnetic floc;
e. collecting the magnetic floc in the second chamber on a second magnetic collector;
f. removing the magnetic floc from the second magnetic collector; and
g. separating the magnetic seed from the magnetic floc and returning the magnetic seed to the second chamber.

16. The method of claim 15 including mixing one or more sulfides with the water in the first chamber and precipitating heavy metals from the water, and wherein the heavy metals attach to the magnetic seed and form a part of the magnetic particles.

17. The method of claim 16 further including adding waste aluminum sludge to the water in the first chamber and maintaining the pH such that aluminum is maintained in solution.

18. The method of claim 15 wherein the first magnetic separator is disposed in the first chamber and the second magnetic collector is disposed in the second chamber, and wherein the first magnetic collector and second magnetic collector are rotary magnetic collectors and the method includes at least partially submerging each rotary magnetic collector in the water in a respective chamber and rotating the magnetic collector through the water so as to collect magnetic particles or magnetic floc.

19. A method of removing contaminants from cooling water comprising: directing the cooling water into a chamber, mixing magnetic seed with the cooling water and attracting the contaminants to the magnetic seed to form magnetic particles; collecting the magnetic particles on a magnetic collector so as to remove the contaminants from the cooling water; and removing the magnetic particles from the magnetic collector.

20. The method of claim 19 including performing a lime softening process on the water and precipitating scalants or corrosive compounds from the cooling water; attracting the precipitated scalants or corrosive compounds to the magnetic seed and removing the scalants or corrosive compounds from the cooling water by collecting the magnetic seed having the scalants or corrosive compounds attached thereto by a magnetic collector.
